(19) United States
(12) Patent Application Publication
(10) Pub. No.: US 2015/0370616 A1
(43) Pub. Date: Dec. 24, 2015

(54) METHOD AND SYSTEM FOR RECOMMENDING COMPUTER PRODUCTS ON THE BASIS OF OBSERVED USAGE PATTERNS OF A COMPUTATIONAL DEVICE OF KNOWN CONFIGURATION

(71) Applicant: Harold Lee Peterson, Scotts Valley, CA (US)

(72) Inventor: Harold Lee Peterson, Scotts Valley, CA (US)

(21) Appl. No.: 14/311,290

(22) Filed: Jun. 21, 2014

(51) Int. Cl. G06F 9/54; G06N 5/02

(52) U.S. Cl. CPC G06F 9/541; G06N 5/02

(57) ABSTRACT

A computer implemented method and system for locally or remotely monitoring any system process or user action on a specific computer device, recording data that summarizes any patterns in usage, and displaying recommendation to the user of actions that could be taken, and products that could be purchased that would in any way better the overall user experience. Possibilities for such a system are quite broad, some examples include identifying out-of-date software which possesses both security and system performance issues, identifying the “type of user” and suggesting alternate more appropriate pieces of software and hardware that would better suit the user, for example suggesting a more powerful graphics processor for a serious gamer, an upgrade in RAM for a high intensity analyst, an easier to use software suite for a casual user, an upgraded battery for a smart phone when the batter is often low, a reminder to restart your device occasionally for system updates, etc. Such a system could enhance the general user experience for a wide variety of users on a wide variety of devices.

### FIELD OF THE INVENTION

The present invention relates to monitoring use of a computer system and automatically determining and suggesting possible actions to be taken to provide great efficacy of the computer system.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

The prior art enables use of a computer system for any of a variety of uses. Possible examples of a computer system may include a desktop computer, a notebook computer, a tablet computer, a smart phone, a television, a video game system, and any other computer device. Though the course of daily use of any of these computer systems a user may perform certain tasks, or use certain pieces of software extensively. Some actions taken by a user may directly reduce the overall efficacy of the system in use. Some often repeated actions taken by a user may also be performed more effectively under different system configurations.

There is therefore a long-felt need to enable a system to automatically monitor any actions being performed on a computer system, and upon analysis of these actions recommend steps that may be taken by a user to increase the overall efficacy of the system in use. Examples of such recommended actions may include performing system upgrades to either the software or hardware, performing general system maintenance, modifying a user action, and various others steps.

### SUMMARY AND OBJECTS OF THE INVENTION

Towards the object of enabling a system for monitoring user action patterns on a given computer system and other objects that will be made obvious in light of the present disclosure, a system and method are provided that enable computer implemented monitoring, recording, and analyzing any usage patterns by one or more users of a computational device. Data recorded may include software run incidences and run times, specific indications of user interaction with the software, software revisions currently installed, hardware elements currently installed, manual manipulation events such as a physical button press on the device or on a touchscreen, activity by or on an electronic communication network, as well as any other actions initiated automatically or directly the user on the computer system. Analysis of such patterns may include the determination of the functionality of software and hardware being used, and the determination of whether or not alternative software or hardware exist that could be utilized to increase overall efficacy of the computer system.

If the analysis of a usage pattern yields a possible alternative product, that alternative product may include one or more of a newer version of a currently installed product, an entirely alternate product that accomplishes substantively similar functionality, a product that operates synergistically with the current product, a separate electronic device which may or may not operate synergistically with the current computer system.

The monitoring system may operate within the computation device, or operate externally and communicate with the device by means of any electronic network to monitor usage patterns, or both.

The analysis may be performed automatically based on a variable schedule, or as the result of a user request. In the case that the monitoring system is operating from an external processor, the user request for analysis is transmitted by means of the electronic network.

In the case that analysis determined that an action should be taken by the user to modify a software elements, the system may direct the user to a web site where the user may access the appropriate software for direct download by means of the electronic network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a chart depicting a possible network configuration that allows the use of the present invention.

FIG. 2 is a flow chart depicting the process of monitoring use of a computational system, producing records of usage, analyzing records, and displaying recommendations of possible actions to a user, in one embodiment of the present invention.

FIG. 3 is a flow chart depicting a possible monitoring element of the present invention, wherein monitoring includes operating system errors.

FIG. 4 is a flow chart depicting a possible use of the present invention to recommend making a change to the computer hardware to increase overall efficacy of the system.

FIG. 5 is a flow chart depicting a possible use of the present invention to recommend making a change to the computer software to increase overall efficacy of the system.

FIG. 6 is a flow chart depicting a possible use of the present invention to recommend making a change to the user interaction with the system to increase overall efficacy of the system.

FIG. 7 is a chart depicting an exemplary monitored system to be used with the present invention.

### DETAILED DESCRIPTION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processors for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

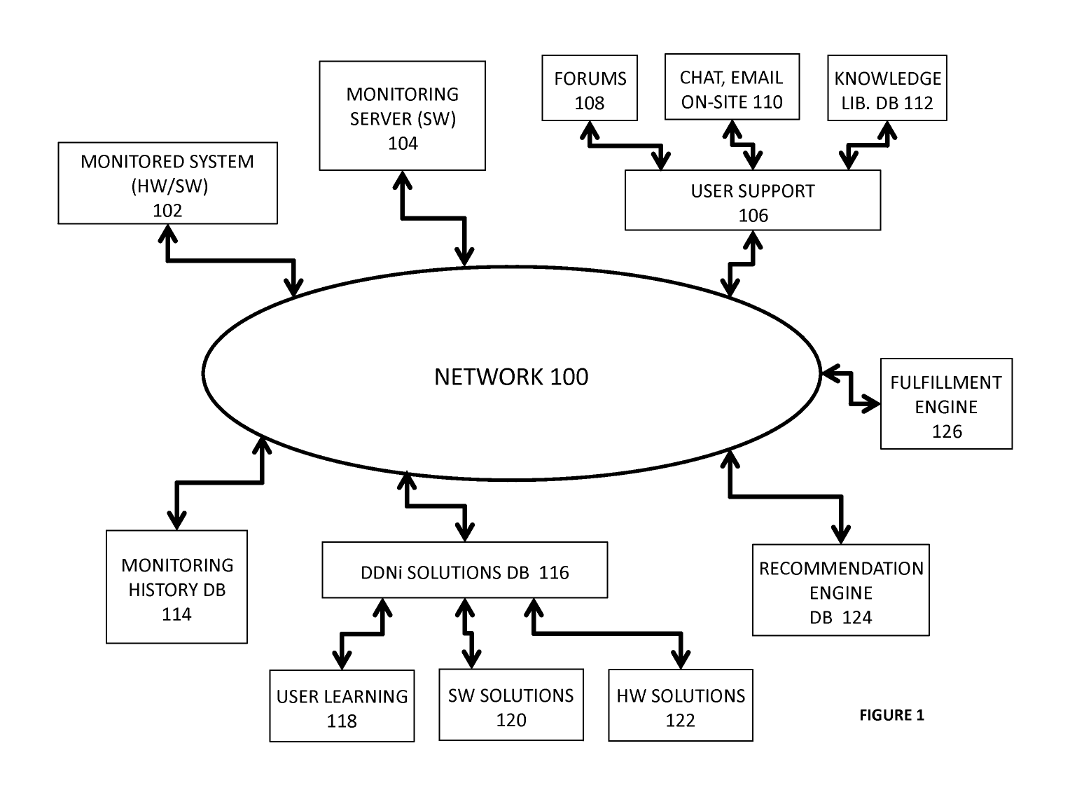

Referring now to FIG. 1, FIG. 1 is a chart depicting a possible network configuration that allows the use of the present invention. A given network 100 making use of the present invention would include first a monitored system 102 which is operated by a user and observed by a monitoring server 104. A monitored system 102 would be include desktop, laptop, and tablet computers along with smart phones, PDAs, or any other suitable computing device known in the art with a network connection. Additionally, on the network, is a user support server 106 wherein users of the service can engage with support staff and other users on forums 108, or on-site chat 110. Additional support 106 can be found in knowledge bases of FAQs 112. The results of the monitoring server are forwarded to a monitoring history database 114. Further communicating to the network 100 is a solutions server 116. The solutions database 116 contains recommendations for user learning 118 to suggest options changes in currently owned software and hardware. The solutions database 116 further includes recommendations for software solutions 120 and hardware solutions 122. A recommendation engine 124 communicating with the network 100 and especially the solutions database 116 observes the monitoring history database 114 and the solutions database 116 and through comparison makes a recommendation. Finally, a fulfillment engine 126 serves as to carry out the recommendations made by the recommendation engine 124 for a user of the monitored system 102. I should be understood that the network configuration of FIG. 1 portrays a plurality of computer systems or nodes. Many of these computer systems could be consolidated for a minimalist approach. For example the monitoring server 104 may also contain that monitoring history database 114. The only computer system which must truly be separate from other objects of the invention is the monitored system 102.

In order to operate correctly, the monitored system 102 would be required to give permissions to the monitoring server 104 such that the monitoring server 104 is capable of accessing the event logs stored on the monitored system 102.

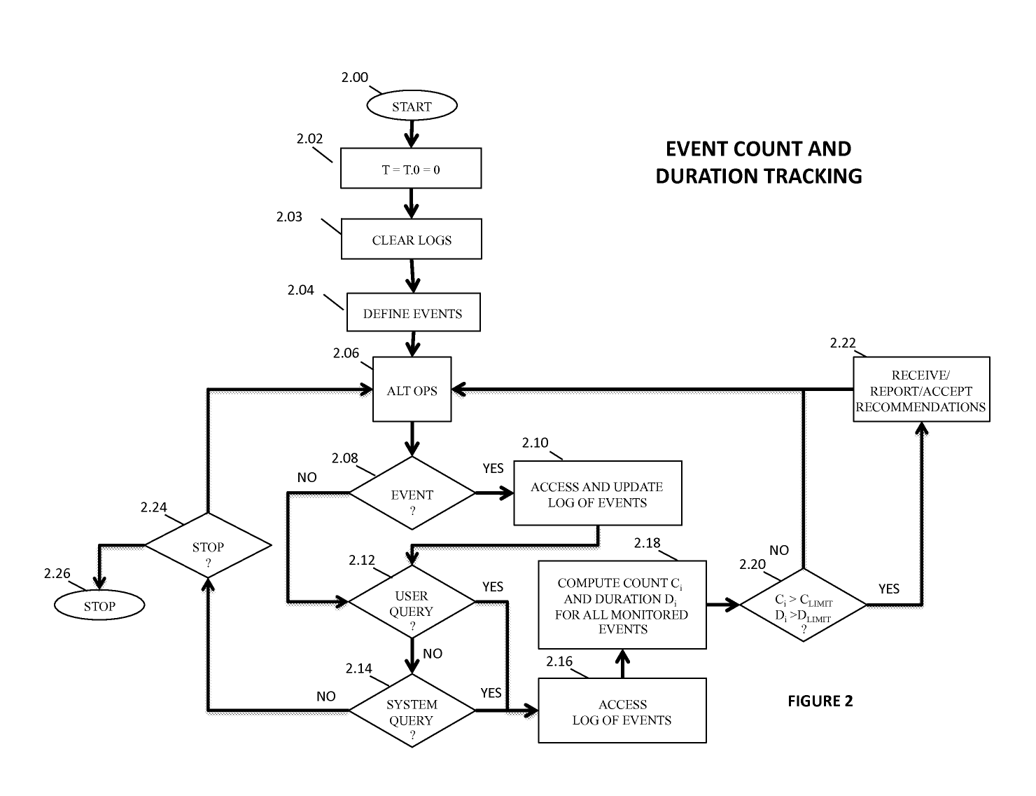

Referring now to FIG. 2, FIG. 2 is a flow chart depicting the process of monitoring use of a computational system, producing records of usage, analyzing records, and displaying recommendations of possible actions to a user, in one embodiment of the present invention. In order to monitor another system, first there is a clean slate. At time zero (2.02) any event logs would be cleared (2.03). Then a selected event or list of events is defined (2.04). These events consist of the data used by the invented monitoring system to make recommendations. These events would be specified by either the monitoring server 104 or potentially even the monitored system 102 if the user had specific concerns. An illustrative list of potential events is included in the “parameters” column of Table 1 included in this disclosure. Next, the monitoring server observes (2.06). This process consists of collecting data about the monitored system over the network 100. This data consists of event data. Should a defined event occur (2.08), the monitoring server 104 will update the event log stored in the history database 114 for frequency and duration (2.10). A user can inquire into the status of these events (2.12) and the system may be set up to make automated queries into the status of event logs (2.14). The queries then access the event logs (2.16). If the events in the logs exceed predetermined count or duration values (2.20), then a recommendation engine 124 will provide recommendations to the user of the monitored system 102 (2.22).

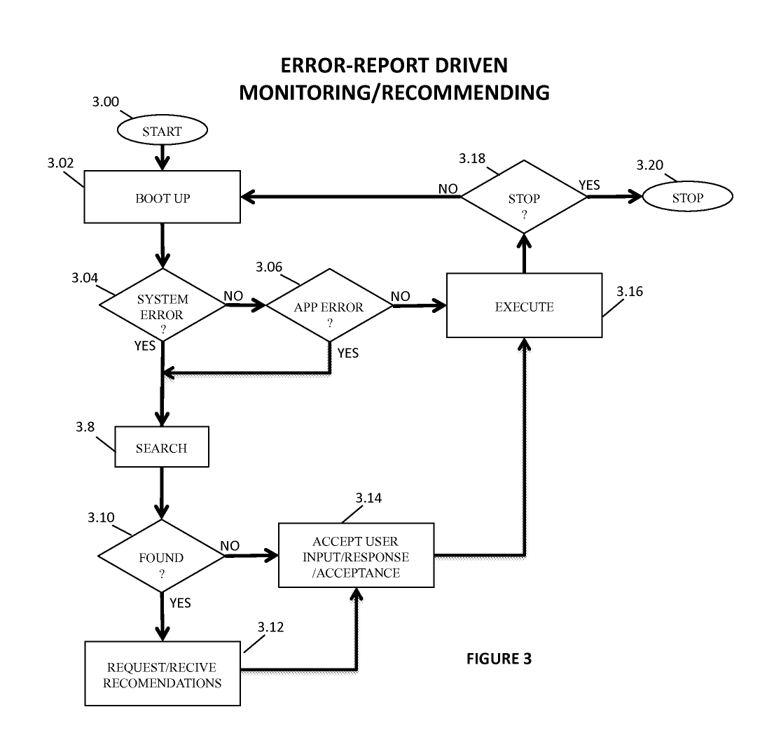

Referring now to FIG. 3, FIG. 3 is a flow chart depicting a possible monitoring element of the present invention, wherein monitoring includes operating system errors. While a system is on (3.02), a monitoring server observes the status of the system as operated by a user. If there is a system error (3.04) or an application error (3.06), the monitoring server will engage a database to search for comparable errors and solutions (3.08). If a match is found (3.10), a recommendation engine 124 will suggest a solution to the user's error problem (3.12). If no solution is found, the invented system will accept user input before taking action (3.14). The invented method then provides a means to achieve the recommendation (3.16). This means would consist of providing links to software updates, directing the user to update user settings, or providing a link to acquire new hardware all through a user GUI or client software.

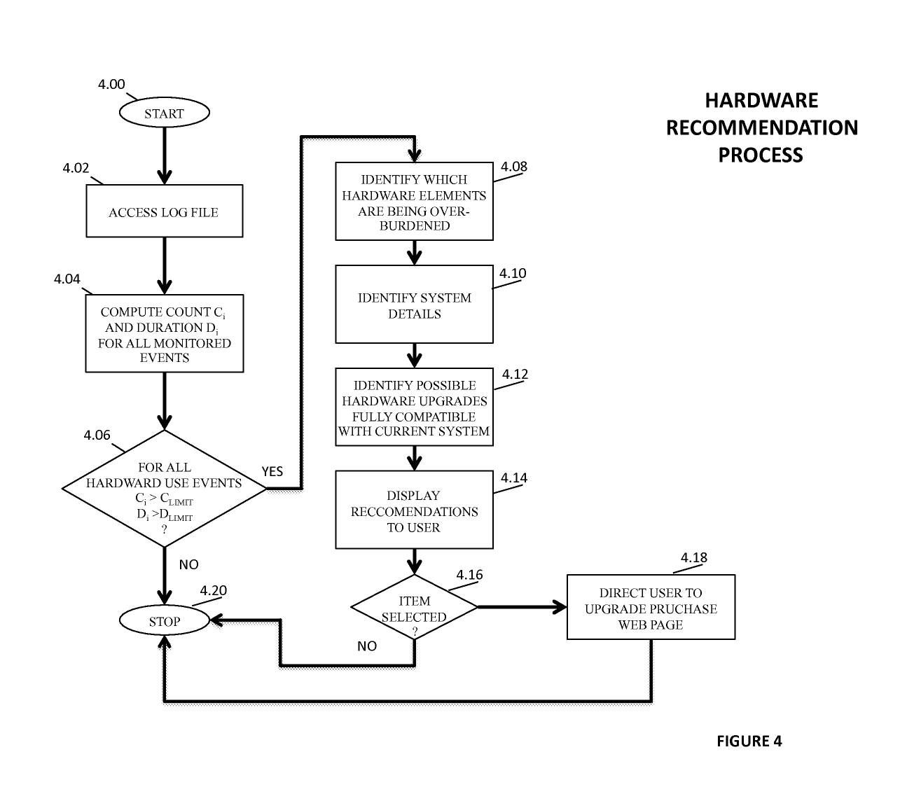

Referring now to FIG. 4, FIG. 4 is a flow chart depicting a possible use of the present invention to recommend making a change to the computer hardware to increase overall efficacy of the system. First, the monitoring server 104 will observe a log file for the monitored system 102 (4.02). For each relevant event, there will be a recorded frequency of occurrence and a length (4.04-4.06). For each relevant event, the monitoring server will look to see if various hardware elements, such as a graphics card, are overburdened (4.08). A finding of overburdened will trigger an observation of the system details (4.10), then identification of hardware replacements which are compatible with the system and would better handle the required load (4.12). The new hardware is then recommended to the user through a GUI (4.14). A link to purchase the new hardware is then provided to a user who accepts the recommendation (4.18) either through a website or an inclusive client software interface. The use term “overburdened” does not necessarily require system resources to be overly taxed. In this case, overburdened can refer to system intuition of user experience. For example, the monitoring server would detect that the monitored system (a laptop) was utilizing open and closed often. The recommendation engine 124 would then suggest that the user purchase a tablet computer with a means provided by the fulfillment engine 126.

During this, and other disclosed processes, the recommendation engine 124 would certify that the new hardware component was compatible with the current system or current hardware. Should an entire system update be recommended, this determination is very easy. If less than a full system update is required, the recommendation engine 124 would consult the solutions database 116. This certification would come from and analysis of the information stored on the solutions database 116.

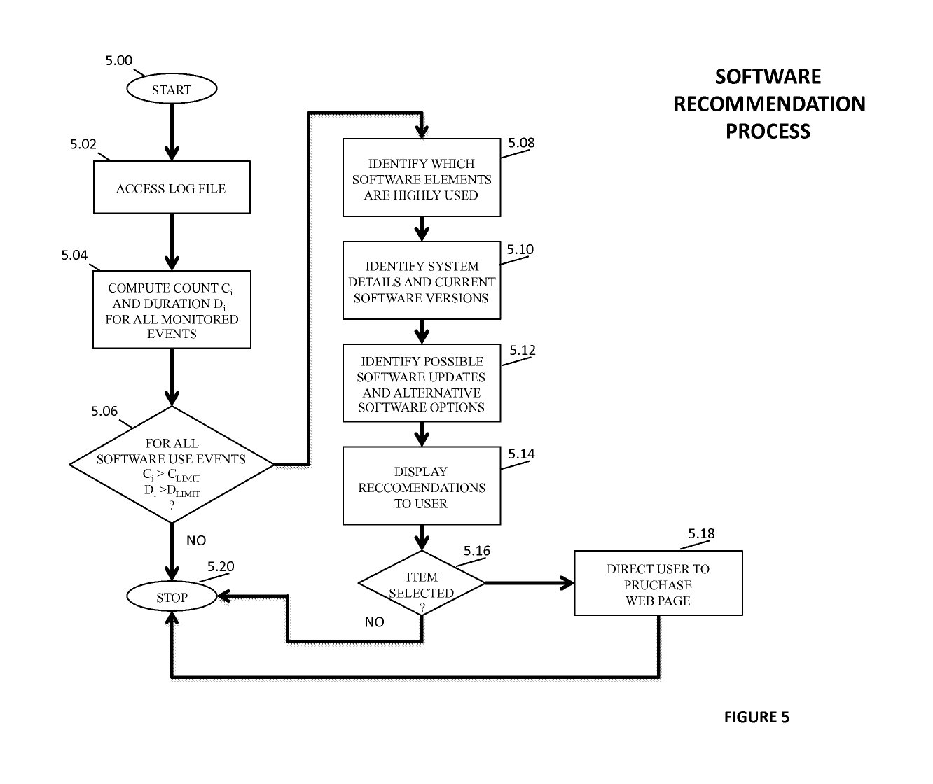

Referring now to FIG. 5, FIG. 5 is a flow chart depicting a possible use of the present invention to recommend making a change to the computer software to increase overall efficacy of the system. First, the monitoring server 104 will observe a log file for the monitored system 102 (5.02). For each relevant event, there will be a recorded frequency of occurrence and a length (5.04). For each relevant event, the monitoring server will look to see if various software elements, such as a PDF writer, are often used (5.08). If said software is often used the system will trigger an observation of the software version and or functions (5.10), then and identification of updates and alternative software which may be better suited for the needs of the user that are compatible with the system and would better handle the required load (5.12). The new software is then recommended to the user through a GUI (5.14). A link to purchase the new software is then provided to a user who accepts the recommendation (5.18) either through a website or an inclusive client software interface. Additionally, the monitoring system will observe drivers for hardware components and notify the user of the monitored system 102 that newer drivers are available.

During this process the recommendation engine 124 would certify that the new software program was compatible with current software on the system. Should an entire system update be recommended, this determination is very easy. If less than a full system update is required, the recommendation engine 124 would consult the solutions database 116.

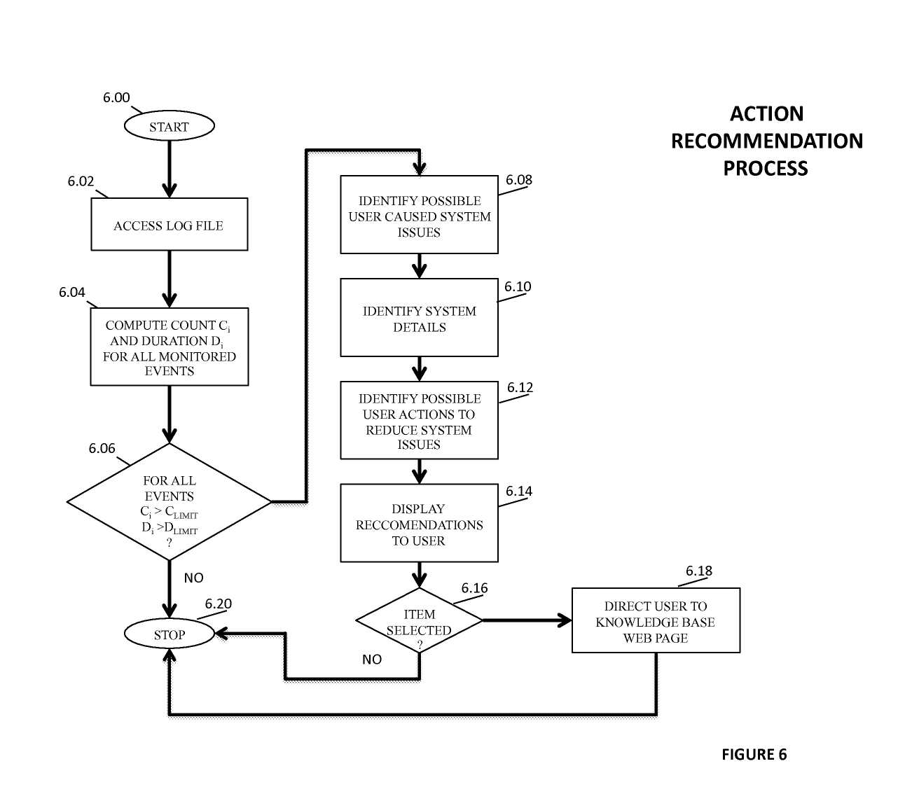

Referring now to FIG. 6, FIG. 6 is a flow chart depicting a possible use of the present invention to recommend making a change to the user interaction with the system to increase overall efficacy of the system. First, the monitoring server 104 will observe a log file for the monitored system 102 (6.02). For each relevant event, there will be a recorded frequency of occurrence and a length (6.04). For each relevant event, the monitoring server will look to see if various user actions are causing negative events (6.08). After inspecting system status (6.10), should a user action be responsible for the negative events, the monitoring server 104 identifies the actions taken by the user (6.12) and the recommendation engine 124 will display a recommendation for alternative user action which would not cause negative events (6.14). Further provided, would be a website with additional details concerning the issue (6.18). As an alternative to a website, information could be displayed through a mobile app or client software which did not make sue of a web browser program.

As an illustrative example, the monitoring server 104 would notice if the monitored system 102 was running multiple applications which both made use of the same network port (i.e. a large data transfer and a VoIP both assigned to port 80) and thus encountered latency issues. The monitoring server 104 would consult the solutions database 116 which would note that the VoIP program had settings which when altered would change the network port used, thereby improving latency of the system. A knowledge base website, mobile app, or client software would then provide details concerning internet latency and port usage.

Below, Table 1 details numerous examples of both hardware and software modifications the invented method would entail.

TABLE 1

| PARAMETER | RELEVANCE | RECOMMENDATION |
|---|---|---|
| BATTERY OFTEN LOW | System underpowered for | System/Battery Upgrade |
| | mobile | |
| LAPTOP LID FREQUENTLY | Screen Access | Purchase Tablet Computer |
| OPEN AND CLOSED | | |
| FREQUENT VoIP USE | Telephony focus | Smart phone possibly more |
| | | appropriate |
| FREQUENT VIDEO | Screen quality important | Screen Upgrade |
| RENDERING | | |
| FREQUENT USE OF APPS | User dependent on | Recommend Specific Alternate |
| HAVING CLOUD-BASED | archaic/isolated software | Cloud Services |
| ALTENATIVES | paradigm | |
| TELEPHONY SESSIONS | Poor cellular system coverage | Offer alternative telephony |
| OFTER DROPPED | | carrier services |
| HIGH FIDELITY AUDIO | Audio output quality important | Audio electronics upgrades |
| OFTEN RENDERED | | |
| FREQUENT LOCATION | Lower system weight desirable | Tablet computer or |
| SHIFTING | | Smartphone |
| WIDELY RANGING | Travel services desirable | Offer travel services |
| LOCATION SHIFTING | | |
| FREQUENT VIDEO EDITING | High intensity computing | System upgrade |
| | required | |
| FREQUENT E-GAME | High intensity computing | System upgrade |
| EDITING & RENDERING | required | |
| PRIMARY ACTIVITY OF | Convenience of access to | Tablet computer |
| ENTERTAINMANT ACCESS | screen desirable | recommendation |
| BOOT-UP TIMES SLOW | CPU & memory overloaded | System Upgrade |
| SLOW APPS LAUNCH TIME | CPU & memory overloaded | System Upgrade |
| INFREQUENT TEXTUAL | Physical keyboard of low value | Tablet or Smartphone |
| INPUT | | |
| FREQUENT TEXTUAL | Low system loading | Low cost system replacements |
| DISPLAY/INFREQUENT | | |
| VIDEO RENDERING | | |
| FREQUENT UPLOADING OF | High intensity bandwidth | System upgrade |
| LARGE DATA FILES | desired | |
| FREQUENT POWERING | User desires low risk of low | Suggest higher battery capacity |
| FROM FIXED POWER | power states | to increase confidence |
| RECEPTACLES | | |
| HIGH DATA TRANSMISSION | Costing of telephony vendor | Suggest alternate telephony |
| VIA TELEPHONY | significant | services |
| FREQUENT RESTART | System is buggy/faulty and/or | Diagnostic & repair service |
| OPERATIONS | overloaded resources | offers |
| FREQUENT ESCAPE | Conflicting | Offer(s) of software revision |
| FUNCTIONS | software/overloaded resources | provision & diagnostic & repair |
| | | service |
| FREQUENT SYSTEM | Conflicting software | Offer(s) of software revision |
| SOFTWARE CONFLICT | | provision & diagnostic & repair |
| REPORTS | | service offers |
| FREQUENT MEMORY | Memory overload | Memory/system upgrade |
| OVERLOAD REPORTS | | |

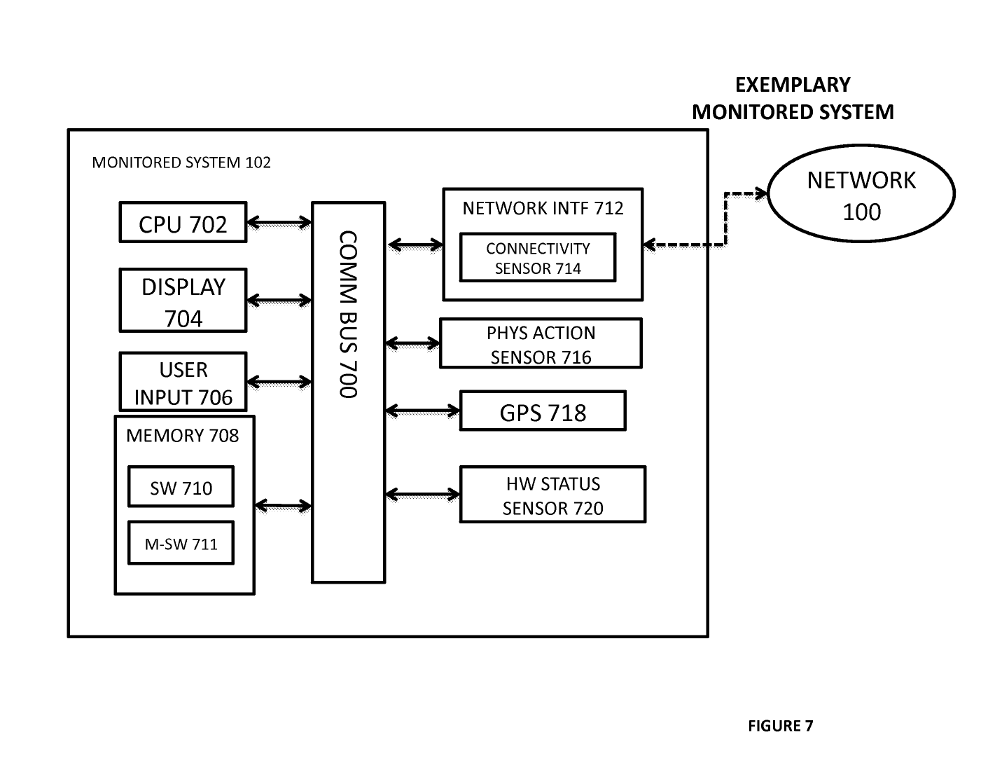

Referring now to FIG. 7, FIG. 7 is a chart depicting an exemplary monitored system to be used with the present invention. The monitored system 102 would include a plurality of components which are commonly found on mass produced computational devices. As noted above, a monitored system 102 would be include desktop, laptop, and tablet computers along with smart phones, PDAs, or any other suitable computing device known in the art with a network connection. Examples of such computing devices would include but are not limited to: (a.) a network-communications enabled THINKSTATION WORKSTATION (TM) notebook computer marketed by Lenovo, Inc. of Morrisville, N.C.; (b.) a NIVEUS 5200 computer workstation marketed by Penguin Computing of Fremont, Calif. and running a LINUX (TM) operating system or a UNIX (TM) operating system; (c.) a network-communications enabled personal computer configured for running WINDOWS XP (TM), VISTA (TM) or WINDOWS 7 (TM) operating system marketed by Microsoft Corporation of Redmond, Wash; (d.) a MACBOOK PRO (TM) personal computer as marketed by Apple, Inc. of Cupertino, Calif.; (e.) an IPAD (TM) tablet computer as marketed by Apple, Inc. of Cupertino, Calif.; (f.) an IPHONE (TM) cellular telephone as marketed by Apple, Inc. of Cupertino, Calif.; (g.) an HTC TITAN II (TM) cellular telephone as marketed by AT&T, Inc. of Dallas, Tex. and running a WINDOWS 7 (TM) operating system as marketed by Microsoft Corporation of Redmond, Wash.; (h.) a GALAXY NEXUS (TM) smart phone as marketed by Samsung Group of Seoul, Republic of Korea or and running an ANDROID (TM); (i.) a TOUGHPAD (TM) tablet computer as marketed by Panasonic Corporation of Kadoma, Osaka, Japan and running an ANDROID (TM) operating system as marketed by Google, Inc. of Mountain View, Calif.; or (j.) other suitable mobile electronic device, wireless communications device, computational system or electronic communications device known in the art.

A monitored system 102 would include a plurality of components communicatively coupled by a communications BUS 700. The plurality of components would include a CPU 702, a graphical display for the user 704. The monitored system would further include a means of providing user input 706 such as a keyboard, touchscreen, or mouse. Each monitored system 102 would include a memory 708, the memory storing system software 710. The system software 710 would include an operating system, as well as optional entertainment, security, or business software. In order for the system 102 to properly be monitored, additional monitoring software 711 would be included which among other things scans metadata created by other system software 710 to gather the parameters and input used to produce recommendations. The monitoring software 711 would also keep track of usage rates of various programs and report this, with other data over the network 100. The monitored system 102 additionally would require a network interface 712. The network interface 712 allows the monitored system 102 to communicate with the network 100. Connected with the network interface 712 would be a connectivity sensor 714 which keeps track of disruptions in service such as call drops or limited network connectivity as well as keep track of usage rates. Such disruptions data would be used in collecting parameters and input used to produce recommendations. The usage rates data refers to packet flows and bandwidth usage. A physical action sensor 716 would also be used in order to collect data such as lid opening and closing, use of the power button, plugging USB or other peripherals, and other actions related to physical manipulation by the user. A GPS 718 sensor would keep track of the location of the monitored system 102. In lieu of a GPS 718, an adequate replacement would be a sensor which used an IP address to locate the monitored system 102. Finally, a hardware status sensor 720 would be used to collect data such as device or chipset temperature, battery charge level, and memory leaks. Each sensor would not necessarily be limited to the examples provided above as these serve merely as illustrative examples. Further, more than one software or hardware sensor would be utilized in order to achieve the desired system. For example, the sensor that collects data on battery charge level would not also be the sensor which collected data on the temperature of the system graphics processor.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a non-transitory computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based herein. Accordingly, the disclosure of the embodiments of the invention is intended to be illustrative, but not limiting, of the scope of the invention, which is set forth in the following claims.

I claim:

1. A computer implemented method performed by a processor, comprising:
a. observing a usage pattern by one or more users of a computational device, the computational device having a plurality of distinguishable software programs;
b. analyzing the usage pattern to determine a pattern of use of at least one of the distinguishable software programs (“the software”);
c. determining the functionality of the software;
d. determining whether an alternative product is identified, wherein the alternative product is compatible with the computational device and is indicated to offer a greater efficacy than the software currently provides in view of the usage pattern; and
e. when an available alternative product is identified that is both compatible with the computational device and is indicated to offer a efficacy than provided by the software in view of the usage pattern, recommending via the computational device an acquisition of the alternative product.

2. The method of claim 1, wherein determining the functionality of the software includes determining a product identity and revision level of the software.

3. The method of claim 1, wherein the available alternative product is an alternate revision of the software.

4. The method of claim 1, wherein the available alternative product comprises a software program that offers substantively similar functionality of the software.

5. The method of claim 1, wherein the available alternative product is a software program that offers substantively similar functionality of the software.

6. The method of claim 1, wherein the available alternative product comprises a software program that functions synergistically with the software.

7. The method of claim 1, wherein the available alternative product comprises an electronic device.

8. The method of claim 7, wherein the electronic device functions synergistically with the software.

9. The method of claim 1, wherein the usage pattern includes detections of manual manipulation events of the computational device.

10. The method of claim 9, wherein at least one manual manipulation event is selected from the group of user events consisting of positioning a screen module relative to a base nodule of the computational device, initiating a powering up of the computational device, initiating a powering up of the computational device, manual key stroke selections of a keyboard of the computational device, and manual touch screen selections of a touch screen of the computational device.

11. The method of claim 1, wherein the usage pattern includes indications of frequency of actuation of the software.

12. The method of claim 1, wherein the usage pattern includes indications of durations of actuation of the software.

13. The method of claim 1, wherein the usage pattern includes indications of user interaction with the software.

14. The method of claim 1, wherein the processor is comprised within the computational device.

15. The method of claim 1, wherein the processor is external to the computational device and is bi-directionally coupled with the computational device via an electronics network.

16. The method of claim 1, wherein the processor includes a first processor and a second processor, wherein the first processor is comprised with the computational device and the second processor is external to the computational device and is bi-directionally coupled with the computational device via an electronics network.

17. The method of claim 1, further comprising:
f. generation by the user via the computational device of a request to acquire the recommended alternative product (“request”); and
g. transmission from the computational device of the request from the alternative product via an electronics communications network.

18. The method of claim 16, further comprising receipt by the computational device of a software code component of the alternate product via the electronics communications network.

19. The method of claim 1, wherein the usage pattern includes indications of activity of at least one element of an electronic communications network in correspondence with the activity of the computational device.

20. An information technology system comprising:
a. means to observe a usage pattern by one or more users of a computational device, the computational device having a plurality of distinguishable software programs;
b. means to analyze the usage pattern to determine a pattern of use of at least one of the distinguishable software programs (“the software”);
c. means to determine the functionality of the software;
d. means to determine whether an alternative product is identified, wherein the alternative product is compatible with the computational device and is indicated to offer a greater efficacy than the software currently provides in view of the usage pattern; and
e. means to recommend to the computational device an acquisition of the alternative product.
